(19) United States
(12) Patent Application Publication
(10) Pub. No.: US 2025/0200958 A1
(43) Pub. Date: Jun. 19, 2025

(54) APPARATUS FOR RECOGNIZING OBJECT AND METHOD THEREOF

(71) Applicants: Hyundai Motor Company, Seoul (KR); Kia Corporation, Seoul (KR)

(72) Inventors: Hyung Jin Cha, Seoul (KR); Sung Moon Jang, Seongnam-si (KR); Nam Hyung Lee, Seoul (KR); Dong Hyo Son, Seongnam-si (KR); Su Min Jo, Seoul (KR); In Sun Lee, Hwaseong-si (KR)

(21) Appl. No.: 18/652,122

(22) Filed: May 1, 2024

(30) Foreign Application Priority Data
Oct. 24, 2023 (KR) 10-2023-0143150

(51) Int. Cl. G06V 10/80; G06T 7/70; G06V 20/58

(52) U.S. Cl. CPC G06V 10/809; G06T 7/70; G06V 20/58; G06T 2207/30252

(57) ABSTRACT

An embodiment object recognition apparatus includes a LIDAR, a camera, a radar, one or more processors, and a storage device storing a program to be executed by the one or more processors, the program including instructions for identifying a fusion track corresponding to an external object acquired through the camera and the radar, identifying a target fusion track, identifying a LIDAR track corresponding to an external object represented by the target fusion track, identifying a target LIDAR track, identifying second LIDAR points that satisfy a position condition, identifying a third LIDAR point that satisfies a distance condition identified based on a distance from a point corresponding to a host vehicle to the second LIDAR point, and associating and storing the target fusion track and the third LIDAR point based on identifying the third LIDAR point.

### CROSS-REFERENCE TO RELATED APPLICATIONS

This application claims the benefit of Korean Patent Application No. 10-2023-0143150, filed on Oct. 24, 2023, which application is hereby incorporated herein by reference.

### TECHNICAL FIELD

The present disclosure relates to an object recognition apparatus and method.

### BACKGROUND

Technology for detecting surrounding environments and distinguishing between obstacles is required for an autonomous vehicle or a vehicle with activated driver assistance devices to adjust its driving path and avoid obstacles with minimal driver intervention.

A vehicle may obtain data indicating the position of an object around the vehicle through a LIDAR. A distance from a LIDAR to an object may be obtained through an interval between the time when a laser is transmitted by the LIDAR and the time when the laser reflected by the object is received. A vehicle may identify the location of a point included outside of the object in a space where the vehicle is located, based on the angle of the transmitted laser and the distance to the object.

An autonomous vehicle or a vehicle with an activated driver assistance device may identify the position of an external object and distinguish obstacles according to a track obtained through a plurality of sensors.

### SUMMARY

The present disclosure relates to an object recognition apparatus and method. Particular embodiments relate to a technology for improving the performance of an object recognition apparatus based on a fusion track identified through a plurality of sensors.

Embodiments of the present disclosure can solve problems occurring in the prior art while advantages achieved by the prior art are maintained intact.

An embodiment of the present disclosure provides an object recognition apparatus and method capable of identifying a LIDAR point corresponding to a target fusion track identified through at least one sensor.

An embodiment of the present disclosure provides an object recognition apparatus and method capable of improving the accuracy of the position of an external object corresponding to a target fusion track identified through at least one sensor.

An embodiment of the present disclosure provides an object recognition apparatus and method for increasing the accuracy of classification of a target fusion track identified through at least one sensor.

The technical problems solvable by embodiments of the present disclosure are not limited to the aforementioned problems, and any other technical problems not mentioned herein will be clearly understood from the following description by those skilled in the art to which the present disclosure pertains.

According to an embodiment of the present disclosure, an object recognition apparatus includes a LIDAR, a camera, a radar, and one or more processors and a storage device storing a program to be executed by the one or more processors.

According to an embodiment, the program may include instructions for identifying at least one fusion track corresponding to at least one external object acquired through the camera and the radar, identifying a target fusion track among the at least one fusion track based on a category into which the at least one fusion track is classified, a longitudinal component of a distance from a point corresponding to a host vehicle to the at least one fusion track, or any combination thereof, identifying at least one LIDAR track corresponding to an external object represented by the target fusion track among the at least one external object acquired through the LIDAR, identifying at least one target LIDAR track among the at least one LIDAR track based on a distance to the at least one LIDAR track from a half line from the point corresponding to the host vehicle to a point corresponding to the target fusion track, wherein the point corresponding to the target fusion track represents a point corresponding to a camera track identified through the camera, represents the at least one external object, and identifies the target fusion track, identifying second LIDAR points that satisfy a position condition determined based on a difference in position between the point corresponding to the target fusion track and a first LIDAR point, a position of the radar, and a position of the camera, or an angle condition identified based on the half line, or any combination thereof, among first LIDAR points of the at least one target LIDAR track, identifying at least one third LIDAR point that satisfies a distance condition identified based on a distance from the point corresponding to the host vehicle to the second LIDAR point, among the second LIDAR points, and associating and storing the target fusion track and the at least one third LIDAR point based on identifying the at least one third LIDAR point.

According to an embodiment, the program further includes instructions for identifying the target fusion track among the at least one fusion track based on the at least one fusion track being identified via the camera and the radar, the at least one fusion track being classified into a specified category, and identifying that the longitudinal component is less than a specified distance.

According to an embodiment, the program further includes instructions for identifying the at least one target LIDAR track among the at least one LIDAR track, based on the half line passing through a track box representing at least one LIDAR track identified through the LIDAR or based on identifying that at least one of vertical distances from the half line to four vertices of the track box is less than or equal to a specified distance.

According to an embodiment, the position condition may comprise a first condition that a first value satisfies a first specified range, the first value being identified based on a difference between a longitudinal position of the radar and a longitudinal position of the first LIDAR point, and a difference between a lateral position of the camera and a lateral position of the first LIDAR point, and a second condition that a second value satisfies a second specified range different from the first specified range, the second value being identified based on a difference between a position of a center point of one of four line segments of a track box representing the target fusion track and a position of the first LIDAR point.

According to an embodiment, the angle condition may comprise a condition that, in a state in which the first LIDAR points are arranged in a decreasing order of angles between each of half lines from the point corresponding to the host vehicle to the first LIDAR points and the half line, a LIDAR point is included within a specified order, among the first LIDAR points.

According to an embodiment, the distance condition may comprise a condition that a LIDAR point is closest to the point corresponding to the host vehicle, among the second LIDAR points.

According to an embodiment, the distance condition may comprise a first condition that the at least one third LIDAR point corresponds to a smallest angle among angles between each of half lines from the point corresponding to the host vehicle to the second LIDAR points and the half line among the second LIDAR points, or a second condition that the at least one third LIDAR point is closest to the target fusion track among the second LIDAR points.

According to an embodiment, the point corresponding to the host vehicle may comprise a center point of a line segment representing a front bumper module of the host vehicle. The point corresponding to the target fusion track may comprise a center point of a track box representing the camera track.

According to an embodiment, the processor may identify a point corresponding to the target fusion track through the camera.

According to an embodiment, the program further includes instructions for identifying a category into which the at least one fusion track is classified, based on a portion of an image acquired through the camera.

According to an embodiment, a category into which the at least one fusion track may be classified represents a pedestrian. The target fusion track has the longitudinal component of the distance from the point corresponding to the host vehicle to the at least one fusion track which is less than a specified distance, among the at least one fusion track identified as the pedestrian through the camera. The at least one target LIDAR track may comprise at least one candidate track capable of corresponding to the pedestrian represented by the target fusion track. The at least one third LIDAR point may comprise a LIDAR point corresponding to the pedestrian represented by the target fusion track.

According to an embodiment, the program further may include instructions for associating and storing the target fusion track and the at least one third LIDAR point by changing the point of the target fusion track to the point of the at least one third LIDAR point, based on identifying the at least one third LIDAR point.

According to an embodiment of the present disclosure, an object recognition method may comprise identifying at least one fusion track corresponding to at least one external object acquired through a camera and a radar, identifying a target fusion track among the at least one fusion track based on a category into which the at least one fusion track is classified, a longitudinal component of a distance from a point corresponding to a host vehicle to the at least one fusion track, or any combination thereof, identifying at least one LIDAR track corresponding to an external object represented by the target fusion track among the at least one external object acquired through a LIDAR, identifying at least one target LIDAR track among the at least one LIDAR track based on a distance to the at least one LIDAR track from a half line from the point corresponding to the host vehicle to a point corresponding to the target fusion track, wherein the point corresponding to the target fusion track represents a point corresponding to a camera track obtained through the camera, represents the at least one external object, and identifies the target fusion track, identifying second LIDAR points that satisfy a position condition determined based on a difference in position between the point corresponding to the target fusion track and a first LIDAR point, a position of the radar, and a position of the camera, or an angle condition identified based on the half line, or any combination thereof, among first LIDAR points of the at least one target LIDAR track, identifying at least one third LIDAR point that satisfies a distance condition identified based on a distance from the point corresponding to the host vehicle to the second LIDAR point, among the second LIDAR points; and associating and storing the target fusion track and the at least one third LIDAR point based on identifying the at least one third LIDAR point.

According to an embodiment, identifying the target fusion track among the at least one fusion track based on the category into which the at least one fusion track is classified, the longitudinal component of the distance from the point corresponding to the host vehicle to the at least one fusion track, or any combination thereof may comprise identifying the target fusion track among the at least one fusion track based on the at least one fusion track being identified via the camera and the radar, the at least one fusion track being classified into a specified category, and the longitudinal component being identified as being less than a specified distance.

According to an embodiment, identifying the at least one target LIDAR track among the at least one LIDAR track based on the distance to the at least one LIDAR track from the half line from the point corresponding to the host vehicle to the point corresponding to the target fusion track may comprise identifying the at least one target LIDAR track among the at least one LIDAR track, based on the half line passing through a track box representing at least one LIDAR track identified through the LIDAR or based on identifying that at least one of vertical distances from the half line to four vertices of the track box is less than or equal to a specified distance.

According to an embodiment, the position condition may comprise a first condition that a first value satisfies a first specified range, the first value being identified based on a difference between a longitudinal position of the radar and a longitudinal position of the first LIDAR point, and a difference between a lateral position of the camera and a lateral position of the first LIDAR point, and a second condition that a second value satisfies a second specified range different from the first specified range, the second value being identified based on a difference between a position of a center point of one of four line segments of a track box representing the target fusion track and a position of the first LIDAR point.

According to an embodiment, the angle condition may comprise a condition that, in a state in which the first LIDAR points are arranged in a decreasing order of angles between each of half lines from the point corresponding to the host vehicle to the first LIDAR points and the half lines, a LIDAR point is included within a specified order, among the first LIDAR points.

According to an embodiment, the distance condition may comprise a condition that a LIDAR point is closest to the point corresponding to the host vehicle, among the second LIDAR points.

According to an embodiment, the distance condition may comprise a first condition that the at least one third LIDAR point corresponds to a smallest angle among angles between each of half lines from the point corresponding to the host vehicle to the second LIDAR points and the half line among the second LIDAR points, or a second condition that the at least one third LIDAR point is closest to the target fusion track among the second LIDAR points.

According to an embodiment, the point corresponding to the host vehicle may comprise a center point of a line segment representing a front bumper module of the host vehicle, and the point corresponding to the target fusion track may comprise a center point of a track box representing the camera track.

### BRIEF DESCRIPTION OF THE DRAWINGS

The above and other objects, features, and advantages of embodiments of the present disclosure will be more apparent from the following detailed description taken in conjunction with the accompanying drawings, in which:

FIG. 1 is a block diagram showing a configuration of an object recognition apparatus according to an embodiment of the present disclosure;

FIG. 2 shows a flowchart of operations for identifying a target fusion track in an object recognition apparatus or an object recognition method according to an embodiment of the present disclosure;

FIG. 3 shows a flowchart of operations for identifying a LIDAR point corresponding to a target fusion track in an object recognition apparatus or object recognition method according to an embodiment of the present disclosure;

FIG. 4 shows an example of identification of a target LIDAR track including a LIDAR point corresponding to a target fusion track in an object recognition apparatus or an object recognition method according to an embodiment of the present disclosure;

FIG. 5 shows a flowchart of operations for associating and storing a target fusion track and a LIDAR point in an object recognition apparatus or an object recognition method according to an embodiment of the present disclosure;

FIG. 6 shows an example of improving the accuracy of the position of an external object corresponding to a target fusion track in an object recognition apparatus or an object recognition method according to an embodiment of the present disclosure;

FIG. 7 shows an example of improving the accuracy of the position of an external object corresponding to a target fusion track in an object recognition apparatus or an object recognition method according to an embodiment of the present disclosure;

FIG. 8 shows an example of a change in the proportion of a radar point corresponding to a target fusion track related to an object recognition apparatus or an object recognition method according to an embodiment of the present disclosure; and

FIG. 9 shows a computing system related to an object recognition apparatus and an object recognition method according to an embodiment of the present disclosure.

### DETAILED DESCRIPTION OF ILLUSTRATIVE EMBODIMENTS

Hereinafter, some embodiments of the present disclosure will be described in detail with reference to the exemplary drawings. In adding the reference numerals to the components of each drawing, it should be noted that the identical or equivalent component is designated by the identical numeral even when it is displayed on other drawings. Further, in describing the embodiment of the present disclosure, a detailed description of well-known features or functions will be omitted in order not to unnecessarily obscure the gist of the present disclosure.

In describing the components of the embodiments according to the present disclosure, terms such as first, second, “A”, “B”, (a), (b), and the like may be used. These terms are merely intended to distinguish one component from another component, and the terms do not limit the nature, sequence, or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and they are not to be interpreted as having ideal or excessively formal meanings unless clearly defined as having such in the present application.

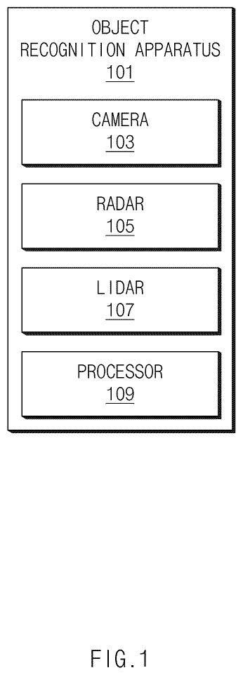

Hereinafter, embodiments of the present disclosure will be described in detail with reference to FIGS. 1 to 9.

FIG. 1 is a block diagram showing a configuration of an object recognition apparatus according to an embodiment of the present disclosure.

Referring to FIG. 1, an object recognition apparatus 101 according to an embodiment of the present disclosure may be implemented inside a vehicle. In this case, the object recognition apparatus 101 may be integrally formed with internal control units of the vehicle or may be implemented as a separate device and connected to the control units of the vehicle by separate connection means.

Referring to FIG. 1, the object recognition apparatus 101 may include a camera 103, a radar 105, a LIDAR 107, and a processor 109.

According to an embodiment, the processor 109 of the object recognition apparatus 101 may identify a track corresponding to an external object based on the camera 103, the radar 105, or the LIDAR 107. The processor 109 of the object recognition apparatus 101 may identify a track corresponding to an external object. A track may refer to an object in a tracking operation of identifying whether an external object identified in a specific frame is the same object as an external object included in at least one frame previously acquired before the specific frame. An identifier may be assigned to the track. The track may refer to a sensor-based output unit for tracking an identified external object over time.

According to an embodiment, the processor 109 of the object recognition apparatus 101 may identify a camera track corresponding to an external object based on a portion of an image acquired through the camera 103. The processor 109 of the object recognition apparatus 101 may identify a radar track corresponding to an external object based on at least one radar point acquired through the radar 105. The processor 109 of the object recognition apparatus 101 may identify a LIDAR track corresponding to an external object based on at least one LIDAR point acquired through the LIDAR 107.

According to an embodiment, the processor 109 of the object recognition apparatus 101 may identify a fusion track based on at least two tracks which correspond to the same external object among the camera track, the radar track, and the LIDAR track. For example, the processor 109 of the object recognition apparatus 101 may identify a fusion track corresponding to an external object based on the camera track and the radar track.

It should be noted that the accuracy of the position of the fusion track when the LIDAR point corresponding to the fusion track and identified through the LIDAR 107 is not identified may be low compared to the accuracy of the position of the fusion track when the LIDAR point corresponding to the fusion track and identified through the LIDAR 107 is identified. Therefore, the processor 109 of the object recognition apparatus 101 may improve the accuracy of the position of the fusion track by identifying the LIDAR point corresponding to the fusion track. Because computation by the processor 109 is required to identify the LIDAR point corresponding to the fusion track, the processor 109 of the object recognition apparatus 101 may identify the LIDAR point corresponding to the fusion track only for fusion tracks that satisfy a specified condition to improve computation efficiency. A fusion track that satisfies a specified condition may be referred to as a target fusion track.

According to an embodiment, the specified condition may include a condition that the fusion track is identified through the camera 103 and the radar 105. The reason for this is that, when a fusion track is identified through the LIDAR 107, the accuracy of the position of an external object corresponding to the fusion track is not significantly improved even though a LIDAR point corresponding to the fusion track is identified. Therefore, for computational efficiency, the processor 109 of the object recognition apparatus 101 may identify the fusion track as a fusion target track based on the fusion track being identified through the camera 103 and the radar 105.

According to an embodiment, the specified condition may include a condition that the fusion track is classified into a specified category (e.g., pedestrian). The processor 109 of the object recognition apparatus 101 may identify a category into which at least one fusion track is classified based on a portion of an image acquired through the camera 103. The reason for this is that, when a pedestrian is positioned to overlap another external object in the field of view of a host vehicle, the processor 109 of the object recognition apparatus 101 may identify a LIDAR point corresponding to the pedestrian identified through the LIDAR 107 as a LIDAR point corresponding to an external object. Compared to fusion tracks identified as non-pedestrian categories, a fusion track identified as a pedestrians may often be identified as overlapping with another external object. Further, the importance of identifying pedestrians may be higher than the importance of identifying objects classified into other categories in autonomous driving or driver assistance driving.

According to an embodiment, the specified condition may include a condition that the longitudinal component of a distance from a point where a fusion track corresponds to the host vehicle (e.g., the center point of a line segment representing the front bumper module of the host vehicle) to the fusion track is less than a specified distance (e.g., about 50 m). To improve computational efficiency, the processor 109 of the object recognition apparatus 101 may not identify the LIDAR point corresponding to a fusion track located beyond the specified distance from the host vehicle.

According to an embodiment, the processor 109 of the object recognition apparatus 101 may identify a target LIDAR track among at least one LIDAR track identified through the LIDAR 107 and corresponding to an external object, based on the position of the external object corresponding to a target fusion track.

The processor 109 of the object recognition apparatus 101 may identify at least one target LIDAR track among the at least one LIDAR track based on a distance to the at least one LIDAR track from a half line drawn from a point corresponding to the host vehicle (e.g., the center point of the line segment representing the front bumper module of the host vehicle) to a point corresponding to the target fusion track (e.g., the center point of a track box representing a camera track). The point corresponding to the target fusion track may represent a point corresponding to a camera track which is identified through a camera, represents at least one external object, and identifies the target fusion track. According to an embodiment, the point corresponding to the target fusion track may include the center point of the track box representing the camera track.

For example, when a half line passes through a track box representing at least one LIDAR track identified through the LIDAR 107, the processor 109 of the object recognition apparatus 101 may identify at least one LIDAR track corresponding to the track box as at least one target LIDAR track.

For example, when at least one of vertical distances from the half line to the four vertices of the track box is less than or equal to a specified distance (e.g., about 1 m), the processor 109 of the object recognition apparatus 101 may identify at least one LIDAR track corresponding to the track box as at least one target LIDAR track.

According to an embodiment, the processor 109 of the object recognition apparatus 101 may identify a point corresponding to a target fusion track through the camera 103. According to an embodiment, at least one target LIDAR track may include at least one candidate track that may correspond to an external object (e.g., an object classified as a pedestrian) represented by the target fusion track.

According to an embodiment, among first LIDAR points constituting at least one target LIDAR track, the processor 109 of the object recognition apparatus 101 may identify second LIDAR points satisfying at least one of a positional condition determined based on a difference in position between the first LIDAR point and a point corresponding to the target fusion track, and the position of the radar 105, and the position of the camera 103, or an angle condition determined based on a half line, or any combination thereof.

For example, the positional conditions may include a condition that a first value, identified based on a difference between the longitudinal position of the radar 105 and the longitudinal position of the first LIDAR point, and a difference between the lateral position of the camera 103 and the lateral position of the first LIDAR point, satisfies a specified range (e.g., less than about 5 m), and a condition that a second value, identified based on a difference between the position of the first LIDAR point and a position of a center point of one of four line segments constituting the track box representing the target fusion track, satisfies a specified range (e.g., less than about 1.25 m) that is different from the specified range.

The first value may be identified through Equation 1 below. “I” may represent the longitudinal position of the radar 105. “p₁” may represent the longitudinal position of the first LIDAR point. “c” may represent the lateral position of the camera 103. “p₂” may represent the lateral position of the first LIDAR point.

$$First value = \sqrt{{( l - {p}_{1} )}^{2} + {( c - {p}_{2} )}^{2}} \qquad Equation 1$$

For example, the angle condition may include a condition that, when the first LIDAR points are arranged in the decreasing order of angles between half lines from the point corresponding to the host vehicle to the first LIDAR points and each of the half lines, a LIDAR point is included within a specified order, among the first LIDAR points.

According to an embodiment, the processor 109 of the object recognition apparatus 101 may identify at least one third LIDAR point that satisfies the distance condition identified based on the distance from the point corresponding to the host vehicle (e.g., the center point of the line segment representing the front bumper module of the host vehicle) to the second LIDAR point, among the second LIDAR points. The at least one third LIDAR point may include a LIDAR point corresponding to a pedestrian, which is a category of the target fusion track.

For example, the distance condition may include a condition that, among the second LIDAR points, the LIDAR point is the closest in distance from the point corresponding to the host vehicle.

For another example, the distance condition may include a condition that the at least one third LIDAR point corresponds to the smallest angle among angles between each of half lines from the point corresponding to the host vehicle to the second LIDAR points and the half line, among the second LIDAR points, and a condition that the at least one third LIDAR point is closest to the target fusion track, among the second LIDAR points.

According to an embodiment, the processor 109 of the object recognition apparatus 101 may associate and store the target fusion track and the at least one third LIDAR point, based on identifying the at least one third LIDAR point.

In autonomous driving or driving based on driver assistance devices, pedestrian identification may be required to ensure safety.

When the accuracy of the position of the fusion track corresponding to an external object classified as a pedestrian is less than a reference value, the processor of the object recognition apparatus may excessively control the host vehicle for a sudden brake or lose control of the host vehicle. Additionally, when the category of the fusion track corresponding to an external object other than a pedestrian is incorrectly recognized as a pedestrian, the processor of the object recognition apparatus may excessively control the host vehicle for a sudden brake or may lose control of the host vehicle.

When a fusion track corresponding to an external object is classified through a camera, the processor of the object recognition apparatus may incorrectly recognize the category of the fusion track. When the position of a fusion track corresponding to an external object is identified through the camera, the processor of the object recognition apparatus may incorrectly identify the position of the fusion track. Accordingly, the processor of the object recognition apparatus may fuse a fusion track and information identified through a LIDAR to reduce the frequency with which the category of the fusion track is incorrectly recognized and to increase the accuracy of the position of the fusion track.

The object recognition apparatus according to an embodiment may associate the target fusion track and the LIDAR point, rather than associating the target fusion track and the LIDAR track. Although a LIDAR track identifies a single external object, the LIDAR track may be separated into multiple tracks or filtered due to low reliability. When the target fusion track and the LIDAR track are associated with each other, the processor of the object recognition apparatus may associate the target fusion track and the LIDAR point rather than associating the target fusion track and the LIDAR track, thereby improving the accuracy of the position of the fusion track.

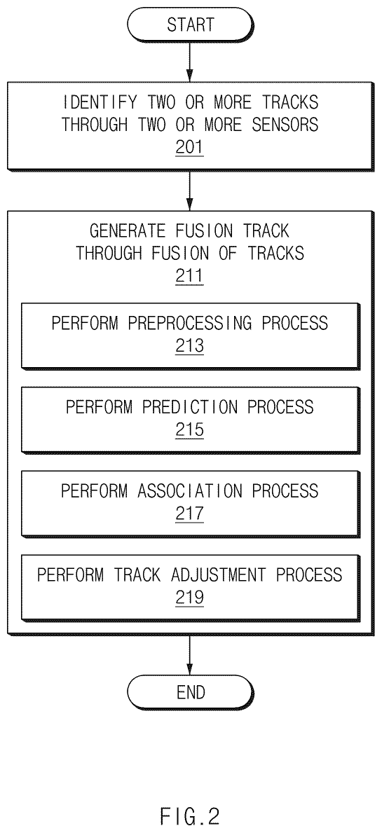

FIG. 2 shows a flowchart of operations for identifying a target fusion track in an object recognition apparatus or an object recognition method according to an embodiment of the present disclosure.

Hereinafter, it is assumed that the object recognition apparatus 101 of FIG. 1 performs the process of FIG. 2. Additionally, in the description of FIG. 2, operations described as being performed by the object recognition apparatus may be understood as being controlled by the processor 109 of the object recognition apparatus 101.

Referring to FIG. 2, in a first operation 201, the processor of the object recognition apparatus according to an embodiment may identify two or more tracks through two or more sensors. For example, the processor of the object recognition apparatus may identify a camera track, which is a track obtained through a camera. The processor of the object recognition apparatus may identify a radar track, which is a track obtained through a radar. The processor of the object recognition apparatus may identify a LIDAR track, which is a track obtained through a LIDAR.

In a second operation 211, the processor of the object recognition apparatus according to an embodiment may generate a fusion track through fusion of tracks. The second operation 211 may include a third operation 213, a fourth operation 215, a fifth operation 217, and a sixth operation 219. A module performing the second operation 211 may include a module performing the third operation 213, a module performing the fourth operation 215, a module performing the fifth operation 217, and a module performing the sixth operation 219.

For example, the processor of the object recognition apparatus may generate one fusion track by fusing at least two of the camera track, the radar track, and the LIDAR track. It should be noted that the tracks which are fused may represent the same external object. In other words, the processor of the object recognition apparatus may generate one fusion track by fusing at least two tracks among a camera track representing a specific object, a radar track representing an object identical to the specific object, and a LIDAR track representing the object identical to the specific object.

In the third operation 213, the processor of the object recognition apparatus according to an embodiment may perform a preprocessing process. According to an embodiment, the processor of the object recognition apparatus may specify a valid track among tracks identified through a sensor. For example, the processor of the object recognition apparatus may identify a track in which the intensity of a signal representing the track is equal to or greater than a reference intensity as a valid track.

In the fourth operation 215, the processor of the object recognition apparatus according to an embodiment may perform a prediction process. The processor of the object recognition apparatus may predict and identify the relative positions of tracks with respect to the host vehicle, which change according to the operation of the host vehicle. The processor of the object recognition apparatus may identify predicted positions of the tracks by adding or subtracting compensation position values to or from the identified positions of the tracks.

In the fifth operation 217, the processor of the object recognition apparatus according to an embodiment may perform an association process. The processor of the object recognition apparatus may identify a reference track and a fiducial track among tracks identified through a sensor and representing the same external object. The processor of the object recognition apparatus may fuse information about tracks representing the same external object and identify them as one fusion track.

In the sixth operation 219, the processor of the object recognition apparatus according to an embodiment may perform a track adjustment process. The processor of the object recognition apparatus may manage the states of identified fusion tracks, merge tracks, delete tracks, and adjust track positions.

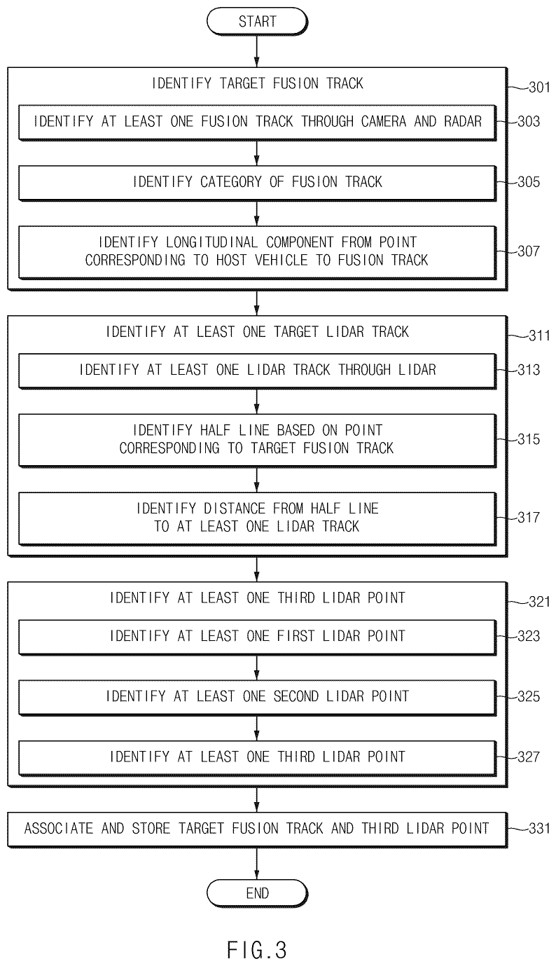

An operation of associating a fusion track and a LIDAR point disclosed in embodiments of the present disclosure may be included in the third operation 213, the fifth operation 217, or the sixth operation 219. The operation of associating the fusion track and LIDAR point disclosed in embodiments of the present disclosure will be described below with reference to FIG. 3.

When the operation of associating the fusion track and the LIDAR point disclosed in embodiments of the present disclosure is included in the third operation, a track representing an external object may be effectively identified even though the intensity of the signal of the track is weak, resulting in reduction in the frequency in which the track representing the external object is deleted. The processor of the object recognition apparatus may improve the performance of the object recognition apparatus by considering tracks representing an external object when generating a fusion track.

FIG. 3 shows a flowchart of operations for identifying a LIDAR point corresponding to a target fusion track in an object recognition apparatus or object recognition method according to an embodiment of the present disclosure.

Hereinafter, it is assumed that the object recognition apparatus 101 of FIG. 1 performs the process of FIG. 3. Additionally, in the description of FIG. 3, operations described as being performed by the object recognition apparatus may be understood as being controlled by the processor 109 of the object recognition apparatus 101.

Referring to FIG. 3, in a first operation 301, the processor of the object recognition apparatus according to an embodiment may identify a target fusion track. The first operation 301 may include a second operation 303, a third operation 305, and a fourth operation 307.

In the second operation 303, the processor of the object recognition apparatus according to an embodiment may identify at least one fusion track through a camera and a radar.

Because the reliability of the fusion track identified through the camera and the radar is higher than the reliability of the fusion track identified through one of the camera and the radar when the category of the fusion track is incorrectly identified, it may be difficult for the processor of the object recognition apparatus to determine whether the fusion track is incorrectly identified. The reliability of the fusion track may refer to a weight given by the object recognition apparatus to identify whether the fusion track is a false track.

Additionally, when the position of the fusion track is incorrectly identified, the validity of the fusion track identified through the camera and the radar is higher than the validity of the fusion track identified through one of the camera and the radar. The validity of a fusion track may refer to the probability that the fusion track is a false track.

In the third operation 305, the processor of the object recognition apparatus according to an embodiment may identify the category of the fusion track. The processor of the object recognition apparatus may identify a category (e.g., pedestrian) into which at least one fusion track is classified, based on a portion of an image acquired through the camera.

In the fourth operation 307, the processor of the object recognition apparatus according to an embodiment may identify a longitudinal component from a point corresponding to the host vehicle to the fusion track. The processor of the object recognition apparatus may include a condition that the longitudinal component of a distance from a point where a fusion track corresponds to the host vehicle (e.g., the center point of a line segment representing the front bumper module of the host vehicle) to the fusion track is less than a specified distance (e.g., about 50 m). To improve computational efficiency, the processor of the object recognition apparatus may not identify a LIDAR point corresponding to a fusion track located beyond a specified distance from the host vehicle.

In a fifth operation 311, the processor of the object recognition apparatus according to an embodiment may identify at least one target LIDAR track. The fifth operation 311 may include a sixth operation 313, a seventh operation 315, and an eighth operation 317. According to an embodiment, at least one target LIDAR track may include at least one candidate track that may correspond to an external object (e.g., an object classified as a pedestrian) represented by the target fusion track.

In the sixth operation 313, the processor of the object recognition apparatus according to an embodiment may identify at least one LIDAR track through a LIDAR. The LIDAR track may include LIDAR points.

In the seventh operation 315, the processor of the object recognition apparatus according to an embodiment may identify a half line based on a point corresponding to the target fusion track. The identified half line may be directed from a point corresponding to the host vehicle (for example, the center point of the line segment representing the front bumper module of the host vehicle) to a point corresponding to the target fusion track (e.g., the center point of the track box representing a camera track). The point corresponding to the target fusion track may represent a point corresponding to a camera track which is identified through a camera, represents at least one external object, and identifies the target fusion track.

In the eighth operation 317, the processor of the object recognition apparatus according to an embodiment may identify a distance from the half line to at least one LIDAR track. The processor of the object recognition apparatus may identify at least one target LIDAR track among the at least one LIDAR track based on a distance to the at least one LIDAR track from a half line from a point corresponding to the host vehicle (e.g., the center point of the line segment representing the front bumper module of the host vehicle) to a point corresponding to the target fusion track (e.g., the center point of a track box representing a camera track).

For example, when a half line passes through a track box representing at least one LIDAR track identified through the LIDAR, the processor of the object recognition apparatus may identify at least one LIDAR track corresponding to the track box as at least one target LIDAR track.

For example, when at least one of vertical distances from the half line to the four vertices of the track box is less than or equal to a specified distance (e.g., about 1 m), the processor of the object recognition apparatus may identify at least one LIDAR track corresponding to the track box as at least one target LIDAR track.

In a ninth operation 321, the processor of the object recognition apparatus according to an embodiment may identify a third LIDAR point. The ninth operation 321 may include a tenth operation 323, an eleventh operation 325, and a twelfth operation 327. The third LIDAR point may represent a pedestrian, which is the category of a target fusion track.

In the tenth operation 323, the processor of the object recognition apparatus according to an embodiment may identify at least one first LIDAR point. The first LIDAR point may be included in at least one target LIDAR track.

In the eleventh operation 325, the processor of the object recognition apparatus according to an embodiment may identify at least one second LIDAR point. According to an embodiment, among first LIDAR points constituting at least one target LIDAR track, the processor of the object recognition apparatus may identify second LIDAR points satisfying at least one of a positional condition determined based on a difference in position between the first LIDAR point and a point corresponding to the target fusion track, and the position of a radar, and the position of a camera, or an angle condition determined based on a half line, or any combination thereof. A specified number of second LIDAR points (e.g., two) may be identified.

For example, the positional conditions may include a condition that a first value, identified based on a difference between the longitudinal position of the radar and the longitudinal position of the first LIDAR point, and a difference between the lateral position of the camera and the lateral position of the first LIDAR point, satisfies a specified range (e.g., less than about 5 m), and a condition that a second value, identified based on a difference between the position of the first LIDAR point and a position of a center point of one of four line segments constituting the track box representing the target fusion track, satisfies a specified range (e.g., less than about 1.25 m) that is different from the specified range.

For example, the angle condition may include a condition that, when the first LIDAR points are arranged in the decreasing order of angles between each of half lines from the point corresponding to the host vehicle to the first LIDAR points and the half line, a LIDAR point is included within a specified order, among the first LIDAR points.

In the twelfth operation 327, the processor of the object recognition apparatus according to an embodiment may identify at least one third LIDAR point. According to an embodiment, the processor of the object recognition apparatus may identify at least one third LIDAR point that satisfies the distance condition identified based on the distance from the point corresponding to the host vehicle (e.g., the center point of the line segment representing the front bumper module of the host vehicle) to the second LIDAR point, among the second LIDAR points. The at least one third LIDAR point may include a LIDAR point corresponding to a pedestrian, which is a category of the target fusion track.

For example, the distance condition may include a condition that, among the second LIDAR points, the LIDAR point is the closest in distance from the point corresponding to the host vehicle.

For another example, the distance condition may include a condition that at least one third LIDAR point corresponds to the smallest angle among angles between each of half lines from the point corresponding to the host vehicle to the second LIDAR points among the second LIDAR points and the half line or a condition that a LIDAR point is closest to the target fusion track among the second LIDAR points.

In the thirteenth operation 329, the processor of the object recognition apparatus according to an embodiment may associate and store the target fusion track and the third LIDAR point. The processor of the object recognition apparatus may store information on the third LIDAR point along with the target fusion track.

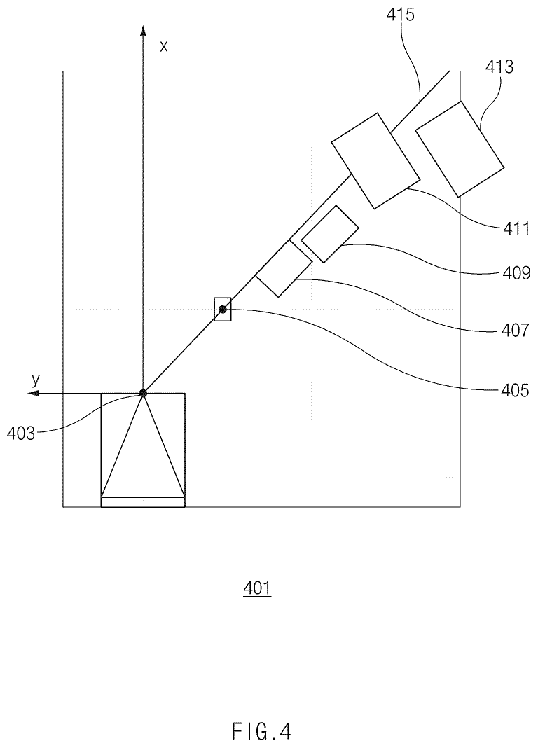

FIG. 4 shows an example of identification of a target LIDAR track including a LIDAR point corresponding to a target fusion track in an object recognition apparatus or an object recognition method according to an embodiment of the present disclosure.

Referring to FIG. 4, in a situation 401, a half line 415 may be directed from a point 403 corresponding to a host vehicle to a point 405 corresponding to a target fusion track. A first LIDAR track 407, a second LIDAR track 409, a third LIDAR track 411, and a fourth LIDAR track 413 may be obtained through a LIDAR. The processor of the object recognition apparatus may identify at least one candidate track that may correspond to an external object indicated by the target fusion track among the first LIDAR track 407, the second LIDAR track 409, the third LIDAR track 411, and the fourth LIDAR track 413. The at least one candidate track may be referred to as a target LIDAR track.

According to an embodiment, the point 405 corresponding to the target fusion track may represent a point corresponding to a camera track which is identified through a camera, represents at least one external object, and identifies the target fusion track.

According to one embodiment, the processor of the object recognition apparatus may identify at least one target LIDAR track among the at least one LIDAR track, based on identifying that the half line 415 passes through a track box representing at least one LIDAR track (e.g., the first LIDAR track 407, the second LIDAR track 409, the third LIDAR track 411, and the fourth LIDAR track 413) identified through LIDAR, or at least one of vertical distances from the half line 415 to the four vertices of the track box is less than or equal to a specified distance.

The processor of the object recognition apparatus may identify the first LIDAR track 407 as a target LIDAR track, based on identifying that the half line 415 passes through a track box represented by the first LIDAR track 407, or at least one of vertical distances from the half line 415 to the four vertices of the track box represented by the first LIDAR track 407 is less than or equal to the specified distance.

The processor of the object recognition apparatus may identify the second LIDAR track 409 as a target LIDAR track, based on identifying that at least one of vertical distances from the half line 415 to the four vertices of the track box represented by the second LIDAR track 409 is less than or equal to the specified distance.

The processor of the object recognition apparatus may identify the third LIDAR track 411 as a target LIDAR track, based on identifying that the half line 415 passes through a track box represented by the third LIDAR track 411, and at least one of vertical distances from the half line 415 to the four vertices of the track box represented by the third LIDAR track 411 is less than or equal to the specified distance.

The processor of the object recognition apparatus may identify the fourth LIDAR track 413 as a target LIDAR track, based on identifying that a distance from the half line 415 to one of the four vertices of a track box represented by the fourth LIDAR track 413 is less than the specified distance.

According to an embodiment, the processor of the object recognition apparatus may identify an equation representing the half line 415 using Equation 2. “a” may represent the longitudinal position of a target fusion track. “b” may represent the lateral position of a target fusion track.

$$a \cdot x - b \cdot y + c = o \qquad Equation 2$$

According to an embodiment, the accuracy of an azimuth angle identified through a camera may be higher than the accuracy of a longitudinal position identified through a camera. Accordingly, the processor of the object recognition apparatus may identify an equation representing the half line 415 based on an angle identified through the camera.

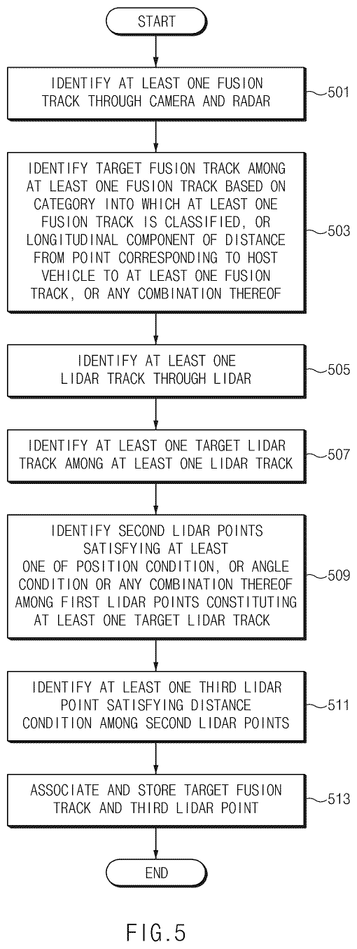

FIG. 5 shows a flowchart of operation of associating and storing a target fusion track and a LIDAR point in an object recognition apparatus or an object recognition method according to an embodiment of the present disclosure.

Hereinafter, it is assumed that the object recognition apparatus 101 of FIG. 1 performs the process of FIG. 5. Additionally, in the description of FIG. 5, operations described as being performed by the object recognition apparatus may be understood as being controlled by the processor 109 of the object recognition apparatus 101.

Referring to FIG. 5, in a first operation 501, the processor of the object recognition apparatus according to an embodiment may identify at least one fusion track through a camera and a radar. The at least one fusion track may correspond to at least one external object.

In a second operation 503, the processor of the object recognition apparatus according to an embodiment may identify a target fusion track among at least one fusion track based on a category into which the at least one fusion track is classified, or the longitudinal component of a distance from a point corresponding to a host vehicle to the at least one fusion track, or any combination thereof.

In a third operation 505, the processor of the object recognition apparatus according to an embodiment may identify at least one LIDAR track through a LIDAR. The LIDAR track may correspond to an external object represented by the target fusion track.

In a fourth operation 507, the processor of the object recognition apparatus according to an embodiment may identify at least one target LIDAR track among the at least one LIDAR track. The processor of the object recognition apparatus may identify at least one target LIDAR track among the at least one LIDAR track based on a distance from a half line from the point corresponding to the host vehicle toward a point corresponding to the target fusion track to the at least one LIDAR track. In other words, the processor of the object recognition apparatus may determine a LIDAR track satisfying a condition among at least one LIDAR track as a target LIDAR track. The processor of the object recognition apparatus may identify whether a LIDAR track satisfies the condition based on the distance from the half line from the point corresponding to the host vehicle toward the point corresponding to the target fusion track to the at least one LIDAR track. When the processor of the object recognition apparatus according to an embodiment fails to identify a target LIDAR track that satisfies the condition among LIDAR tracks, the processor of the object recognition apparatus may end an operation for associating and storing the target fusion track and the LIDAR point.

In a fifth operation 509, the processor of the object recognition apparatus according to an embodiment may identify second LIDAR points that satisfy at least one of a position condition, or an angle condition, or any combination thereof among first LIDAR points constituting at least one target LIDAR track. The position condition may be determined based on a difference in position between a point corresponding to the target fusion track and the first LIDAR point, the position of a radar, and the position of a camera. The angle condition may be identified based on a half line.

In a sixth operation 511, the processor of the object recognition apparatus according to an embodiment may identify at least one third LIDAR point that satisfies the distance condition among the second LIDAR points. The distance condition may be identified based on a distance from the point corresponding to the host vehicle to the second LIDAR point.

In a seventh operation 513, the processor of the object recognition apparatus according to an embodiment may associate and store the target fusion track and at least one third LIDAR point. The processor of the object recognition apparatus may associate and store the target fusion track and the at least one third LIDAR point, based on identifying the at least one third LIDAR point.

The processor of the object recognition apparatus according to an embodiment may associate and store the target fusion track and at least one third LIDAR point by changing the point of the target fusion track to the point of the at least one third LIDAR point, based on identifying the at least one third LIDAR point.

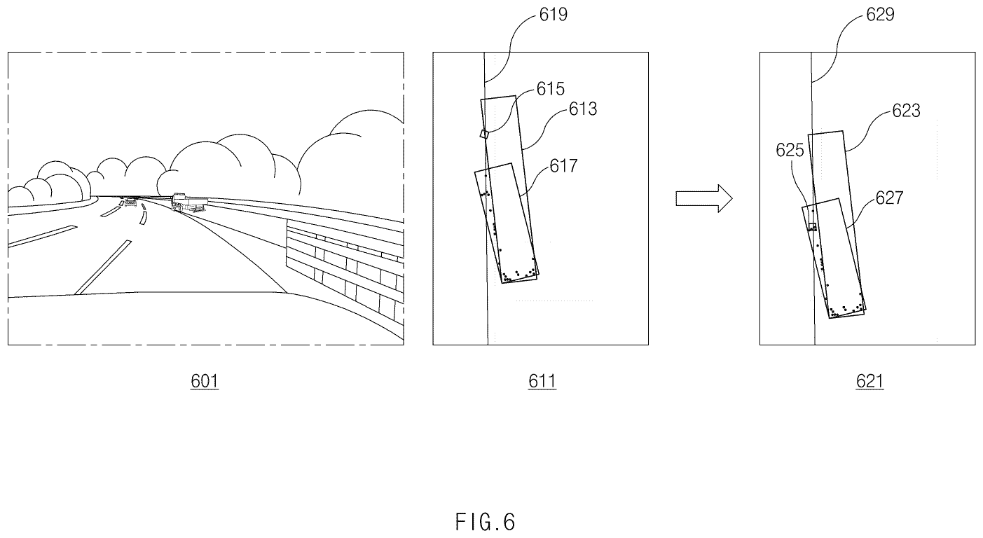

FIG. 6 shows an example of improving the accuracy of the position of an external object corresponding to a target fusion track in an object recognition apparatus or an object recognition method according to an embodiment of the present disclosure.

Referring to FIG. 6, on a camera screen 601, an external object corresponding to a vehicle may overlap an external object corresponding to a pedestrian.

A first output screen 611 may include a first fusion track 613 representing the vehicle, a first target fusion track 615 representing the pedestrian, a first LIDAR track 617 representing the vehicle, and a first half line 619. The first half line 619 may be directed from a point corresponding to a host vehicle to a point corresponding to the first target fusion track 615.

A second output screen 621 includes a second fusion track 623 representing the vehicle, a second target fusion track 625 representing the pedestrian, a second LIDAR track 627 representing the vehicle, and a second half line 629. The second half line 629 may be directed from a point corresponding to the host vehicle to a point corresponding to the second target fusion track 625.

According to an embodiment, a point corresponding to the first target fusion track 615 may represent a point corresponding to a first camera track which is identified through a camera, represents at least one external object, and identifies the first target fusion track.

According to an embodiment, a point corresponding to the second target fusion track 625 may represent a point corresponding to a second camera track which is identified through the camera, represents at least one external object, and identifies the second target fusion track.

According to an embodiment, the first output screen 611 may represent a screen output by an existing object recognition apparatus. The LIDAR points representing the pedestrian may be included in the first LIDAR track 617. Accordingly, the processor of the object recognition apparatus may not output a LIDAR track that is different from the first LIDAR track 617 representing the pedestrian through a LIDAR. Because the processor of the object recognition apparatus is unable to identify LIDAR information on the first target fusion track 615, the accuracy of the position of the first target fusion track 615 may be low compared to the accuracy of the position of the target fusion track containing the LIDAR information.

The second output screen 621 may represent a screen output by the object recognition apparatus according to an embodiment. The LIDAR point representing the pedestrian may be included in the second LIDAR track 627. The processor of the object recognition apparatus may identify a target LIDAR track (e.g., the second LIDAR track 627) that is likely to correspond to the second target fusion track 625 among LIDAR tracks, based on the position of the second half line 629.

The processor of the object recognition apparatus may identify at least one second LIDAR point that satisfies the position condition or the angle condition among the at least one first LIDAR point included in the target LIDAR track. The processor of the object recognition apparatus may identify a third LIDAR point that satisfies the distance condition among at least one second LIDAR point. The processor of the object recognition apparatus may associate and store the second target fusion track 625 and the third LIDAR point.

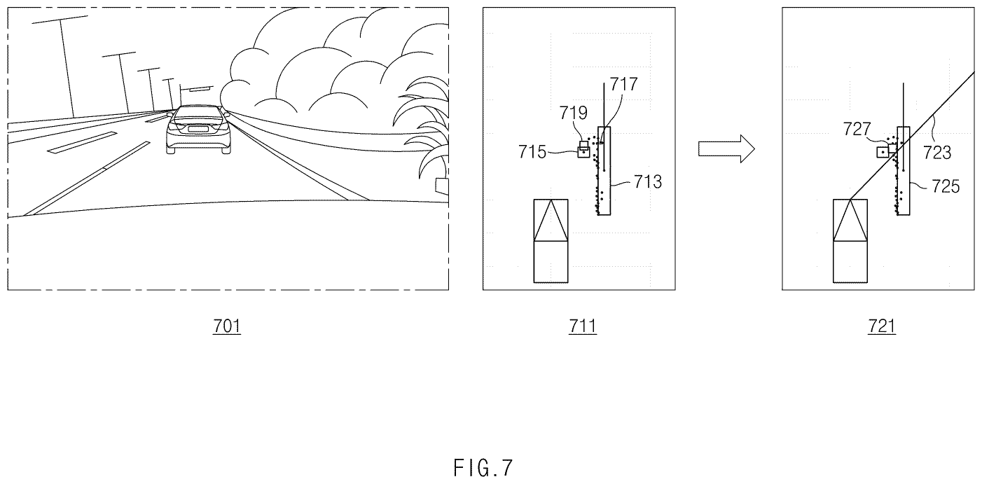

FIG. 7 shows an example of improving the accuracy of the position of an external object corresponding to a target fusion track in an object recognition apparatus or an object recognition method according to an embodiment of the present disclosure.

Referring to FIG. 7, on a camera screen 701, an external object corresponding to a vehicle may overlap an external object corresponding to a bush.

A first output screen 711 may include a camera track 715 representing the bush, a first target fusion track 719 identified based on a radar point 717 representing the bush, and a first LIDAR track 713 representing a structure installed at a road border behind the bush.

A second output screen 721 may include a second target fusion track 727 corresponding to the bush, a second LIDAR track 725 representing the structure installed at the road border behind the bush, and a second half line 723. The half line may be directed from a point corresponding to the host vehicle to a point corresponding to the second target fusion track 727. According to an embodiment, a point corresponding to the second target fusion track 727 may represent a point corresponding to a camera track which is identified through the camera, represents at least one external object, and identifies the second target fusion track 727.

According to an embodiment, the first output screen 711 may represent a screen output by an existing object recognition apparatus. Due to the shaking of the bush, the processor of the object recognition apparatus may obtain the camera track 715 representing the bush and the first target fusion track 719 that is falsely identified based on the radar point 717 representing the bush. Because the first target fusion track 719 is a track identified by two or more sensors, the reliability of the first target fusion track 719 may be higher than the reliability of a track identified by a single sensor. Accordingly, the processor of the object recognition apparatus may output the first target fusion track 719. According to the output of the first target fusion track 719, the host vehicle may slow down or brake to avoid the false object.

The second output screen 721 may represent a screen output by the object recognition apparatus according to an embodiment. The LIDAR point representing the bush may be included in the second LIDAR track 725. The processor of the object recognition apparatus may identify a target LIDAR track (e.g., the second LIDAR track 725) that is likely to correspond to the second target fusion track 727 among LIDAR tracks, based on the position of the second half line 723.

The processor of the object recognition apparatus may identify at least one second LIDAR point that satisfies the position condition or the angle condition among at least one first LIDAR point included in the target LIDAR track (e.g., the second LIDAR track 725). The processor of the object recognition apparatus may identify a third LIDAR point that satisfies the distance condition among at least one second LIDAR point. The processor of the object recognition apparatus may associate and store the second target fusion track 727 and the third LIDAR point.

The processor of the object recognition apparatus may associate the second target fusion track 727 and the LIDAR point, thereby increasing the accuracy of the position of the second target fusion track 727 representing the bush, compared to the accuracy of the position of the first target fusion track 719.

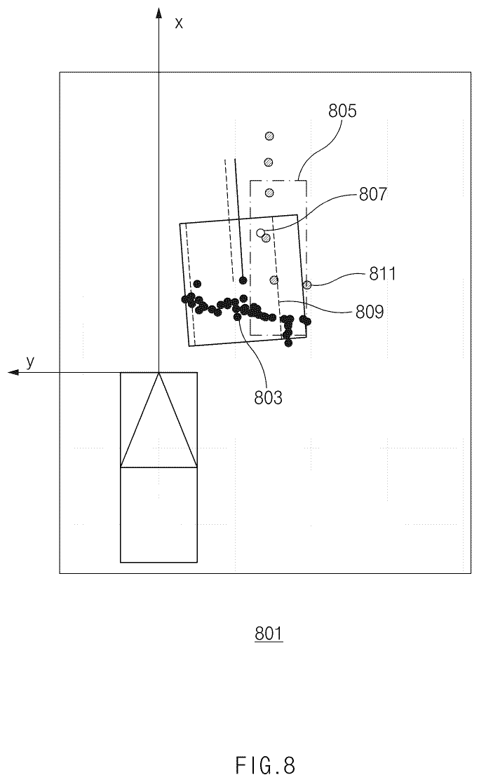

FIG. 8 shows an example of a change in the proportion of a radar point corresponding to a target fusion track related to an object recognition apparatus or an object recognition method according to an embodiment of the present disclosure.

Referring to FIG. 8, a screen 801 may include a LIDAR point 803 acquired through a LIDAR, a camera track 805 acquired through a camera, a radar point 807 acquired through a radar, a target fusion track 809, and a radar detection point 811.

According to an embodiment, the processor of the object recognition apparatus may identify at least one fusion track based on the camera track 805 and the radar point 807. The processor of the object recognition apparatus may identify the target fusion track 809 that satisfies a specified condition among at least one fusion track to improve computational efficiency.

According to an embodiment, the processor of the object recognition apparatus may identify a target LIDAR track among at least one LIDAR track which is identified through the LIDAR and corresponds to an external object, based on the position of the external object corresponding to the target fusion track 809. The processor of the object recognition apparatus may identify the LIDAR point 803 representing the same external object as the external object represented by the target fusion track 809 classified into a category corresponding to a pedestrian.

According to one embodiment, the processor of the object recognition apparatus may identify at least one target LIDAR track among the at least one LIDAR track based on a distance to the at least one LIDAR track from a half line from a point corresponding to the host vehicle (e.g., the center point of the line segment representing the front bumper module of the host vehicle) to a point corresponding to the target fusion track 809 (e.g., the center point of a track box representing a camera track which is identified through the camera, represents at least one external object, and identifies the target fusion track 809).

According to an embodiment, the processor of the object recognition apparatus may identify a LIDAR point that satisfies the position condition, the angle condition, or the distance condition among LIDAR points included in the target LIDAR track. The processor of the object recognition apparatus may associate the identified LIDAR point and the target fusion track in an associating operation (e.g., the fifth operation 217 of FIG. 2).

It should be noted that, when the category of the fusion track is a vehicle, the processor of the object recognition apparatus may identify the fusion track based on the radar detection point as well as the camera track and the radar point to associate the fusion track and the LIDAR point, and the processor of the object recognition apparatus may associate the target fusion track and its corresponding LIDAR point in the associating operation (e.g., the fifth operation 217 of FIG. 2). When associating the target fusion track and the corresponding LIDAR point, the radar detection point may be less affected by external environments such as exhaust gases or water splashes, thereby improving the performance of the object recognition apparatus in identifying the position of an external object.

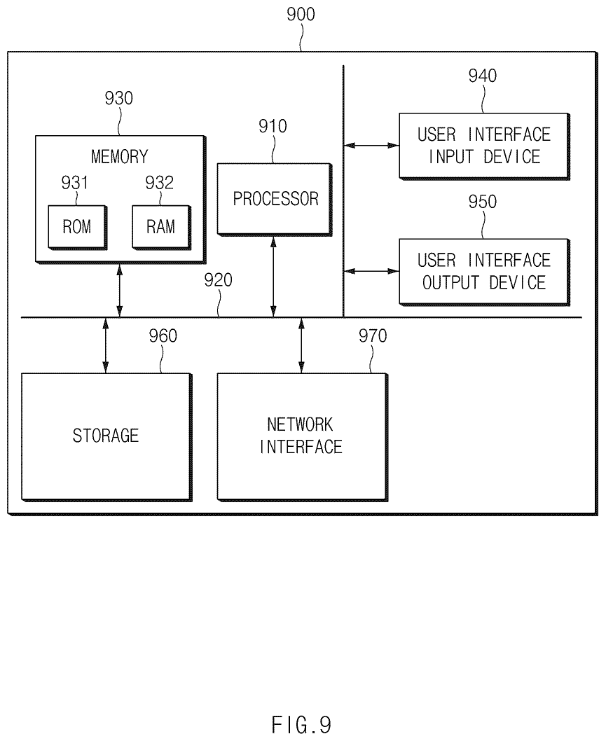

FIG. 9 shows the computing system related to an object recognition apparatus and an object recognition method according to an embodiment of the present disclosure.

Referring to FIG. 9, a computing system 900 may include at least one processor 910, a memory 930, a user interface input device 940, a user interface output device 950, a storage (i.e., a memory) 960, and a network interface 970, which are connected with each other via a bus 920.

The processor 910 may be a central processing unit (CPU) or a semiconductor device that processes instructions stored in the memory 930 and/or the storage 960. The memory 930 and the storage 960 may include various types of volatile or non-volatile storage media. For example, the memory 930 may include a ROM (Read Only Memory) 931 and a RAM (Random Access Memory) 932.

Thus, the operations of the method or the algorithm described in connection with the embodiments disclosed herein may be embodied directly in hardware or a software module executed by the processor 910, or in a combination thereof. The software module may reside on a storage medium (that is, the memory 930 and/or the storage 960) such as a RAM, a flash memory, a ROM, an EPROM, an EEPROM, a register, a hard disk, a removable disk, and a CD-ROM.

The exemplary storage medium may be coupled to the processor 910, and the processor 910 may read information out of the storage medium and may record information in the storage medium. Alternatively, the storage medium may be integrated with the processor 910. The processor and the storage medium may reside in an application specific integrated circuit (ASIC). The ASIC may reside within a user terminal. In another case, the processor and the storage medium may reside in the user terminal as separate components.

The above description is merely illustrative of the technical idea of embodiments of the present disclosure, and various modifications and variations may be made without departing from the essential characteristics of the embodiments of the present disclosure by those skilled in the art to which the present disclosure pertains.

Accordingly, the embodiments disclosed in the present disclosure are not intended to limit the technical idea of the embodiments of the present disclosure but to describe exemplary embodiments of the present disclosure, and the scope of the technical idea of the embodiments of the present disclosure is not limited by the described embodiments. The scope of protection of the present disclosure should be interpreted by the following claims, and all technical ideas within the scope equivalent thereto should be construed as being included in the scope of the present disclosure.

Embodiments of the present technology may identify a LIDAR point corresponding to a target fusion track identified through at least one sensor.

Further, embodiments of the present technology may increase the accuracy of the position of an external object corresponding to a target fusion track identified through at least one sensor.

Further, embodiments of the present technology may reduce the frequency of erroneous braking of autonomous vehicles or vehicles with activated driver assistance devices by increasing the accuracy of the position of an external object corresponding to a target fusion track identified through at least one sensor.

Further, embodiments of the present technology may reduce the frequency of misrecognition of the category of a target fusion track by increasing the accuracy of the position of an external object corresponding to a target fusion track identified through at least one sensor.

In addition, various effects may be provided that are directly or indirectly understood through the disclosure.

Hereinabove, although embodiments of the present disclosure have been described with reference to exemplary embodiments and the accompanying drawings, the embodiments of the present disclosure are not limited thereto, but they may be variously modified and altered by those skilled in the art to which the present disclosure pertains without departing from the spirit and scope of the present disclosure claimed in the following claims.

What is claimed is:

1. An object recognition apparatus, the apparatus comprising:
a LIDAR;
a camera;
a radar;
one or more processors; and
a storage device storing a program to be executed by the one or more processors, the program including instructions for:
identifying at least one fusion track corresponding to at least one external object acquired through the camera and the radar;
identifying a target fusion track among the at least one fusion track based on a category into which the at least one fusion track is classified, a longitudinal component of a distance from a point corresponding to a host vehicle to the at least one fusion track, or any combination thereof;
identifying at least one LIDAR track corresponding to an external object represented by the target fusion track among the at least one external object acquired through the LIDAR;
identifying at least one target LIDAR track among the at least one LIDAR track based on a distance to the at least one LIDAR track from a half line from the point corresponding to the host vehicle to a point corresponding to the target fusion track, wherein the point corresponding to the target fusion track represents a point corresponding to a camera track identified through the camera, represents the at least one external object, and identifies the target fusion track;
identifying second LIDAR points that satisfy a position condition determined based on a difference in position between the point corresponding to the target fusion track and a first LIDAR point, a position of the radar, and a position of the camera, or an angle condition identified based on the half line, or any combination thereof, among first LIDAR points of the at least one target LIDAR track;
identifying at least one third LIDAR point that satisfies a distance condition identified based on a distance from the point corresponding to the host vehicle to the second LIDAR point, among the second LIDAR points; and
associating and storing the target fusion track and the at least one third LIDAR point based on identifying the at least one third LIDAR point.

2. The apparatus of claim 1, wherein the program further includes instructions for identifying the target fusion track among the at least one fusion track based on the at least one fusion track being identified via the camera and the radar, the at least one fusion track being classified into a specified category, and identifying that the longitudinal component is less than a specified distance.

3. The apparatus of claim 1, wherein the program further includes instructions for identifying the at least one target LIDAR track among the at least one LIDAR track, based on the half line passing through a track box representing at least one LIDAR track identified through the LIDAR or based on identifying that at least one of vertical distances from the half line to four vertices of the track box is less than or equal to a specified distance.

4. The apparatus of claim 1, wherein the position condition comprises:
a first condition that a first value satisfies a first specified range, the first value being identified based on a difference between a longitudinal position of the radar and a longitudinal position of the first LIDAR point, and a difference between a lateral position of the camera and a lateral position of the first LIDAR point; and
a second condition that a second value satisfies a second specified range different from the first specified range, the second value being identified based on a difference between a position of a center point of one of four line segments of a track box representing the target fusion track and a position of the first LIDAR point.

5. The apparatus of claim 1, wherein the angle condition comprises a condition that, in a state in which the first LIDAR points are arranged in a decreasing order of angles between each of half lines from the point corresponding to the host vehicle to the first LIDAR points and the half line, a LIDAR point is included within a specified order, among the first LIDAR points.

6. The apparatus of claim 1, wherein the distance condition comprises a condition that a LIDAR point is closest to the point corresponding to the host vehicle, among the second LIDAR points.

7. The apparatus of claim 1, wherein the distance condition comprises a first condition that the at least one third LIDAR point corresponds to a smallest angle among angles between each of half lines from the point corresponding to the host vehicle to the second LIDAR points and the half line among the second LIDAR points, or a second condition that the at least one third LIDAR point is closest to the target fusion track among the second LIDAR points.

8. The apparatus of claim 1, wherein:
the point corresponding to the host vehicle comprises a center point of a line segment representing a front bumper module of the host vehicle; and
the point corresponding to the target fusion track comprises a center point of a track box representing the camera track.

9. The apparatus of claim 1, wherein the program further includes instructions for identifying a point corresponding to the target fusion track through the camera.

10. The apparatus of claim 1, wherein the program further includes instructions for identifying a category into which the at least one fusion track is classified, based on a portion of an image acquired through the camera.

11. The apparatus of claim 1, wherein:
a category into which the at least one fusion track is classified represents a pedestrian;
the target fusion track has the longitudinal component of the distance from the point corresponding to the host vehicle to the at least one fusion track which is less than a specified distance, among the at least one fusion track identified as the pedestrian through the camera;
the at least one target LIDAR track comprises at least one candidate track capable of corresponding to the pedestrian represented by the target fusion track; and
the at least one third LIDAR point comprises a LIDAR point corresponding to the pedestrian represented by the target fusion track.

12. The apparatus of claim 1, wherein the program further includes instructions for associating and storing the target fusion track and the at least one third LIDAR point by changing the point of the target fusion track to the point of the at least one third LIDAR point, based on identifying the at least one third LIDAR point.

13. An object recognition method, the method comprising:
identifying at least one fusion track corresponding to at least one external object acquired through a camera and a radar;
identifying a target fusion track among the at least one fusion track based on a category into which the at least one fusion track is classified, a longitudinal component of a distance from a point corresponding to a host vehicle to the at least one fusion track, or any combination thereof;
identifying at least one LIDAR track corresponding to an external object represented by the target fusion track among the at least one external object acquired through a LIDAR;
identifying at least one target LIDAR track among the at least one LIDAR track based on a distance to the at least one LIDAR track from a half line from the point corresponding to the host vehicle to a point corresponding to the target fusion track, wherein the point corresponding to the target fusion track represents a point corresponding to a camera track obtained through the camera, represents the at least one external object, and identifies the target fusion track;
identifying second LIDAR points that satisfy a position condition determined based on a difference in position between the point corresponding to the target fusion track and a first LIDAR point, a position of the radar, and a position of the camera, or an angle condition identified based on the half line, or any combination thereof, among first LIDAR points of the at least one target LIDAR track;
identifying at least one third LIDAR point that satisfies a distance condition identified based on a distance from the point corresponding to the host vehicle to the second LIDAR point, among the second LIDAR points; and
associating and storing the target fusion track and the at least one third LIDAR point based on identifying the at least one third LIDAR point.

14. The method of claim 13, wherein identifying the target fusion track among the at least one fusion track based on the category into which the at least one fusion track is classified, the longitudinal component of the distance from the point corresponding to the host vehicle to the at least one fusion track, or any combination thereof comprises identifying the target fusion track among the at least one fusion track based on the at least one fusion track being identified via the camera and the radar, the at least one fusion track being classified into a specified category, and the longitudinal component being identified as being less than a specified distance.

15. The method of claim 13, wherein identifying the at least one target LIDAR track among the at least one LIDAR track based on the distance to the at least one LIDAR track from the half line from the point corresponding to the host vehicle to the point corresponding to the target fusion track comprises identifying the at least one target LIDAR track among the at least one LIDAR track, based on the half line passing through a track box representing at least one LIDAR track identified through the LIDAR or based on identifying that at least one of vertical distances from the half line to four vertices of the track box is less than or equal to a specified distance.

16. The method of claim 13, wherein the position condition comprises:
a first condition that a first value satisfies a first specified range, the first value being identified based on a difference between a longitudinal position of the radar and a longitudinal position of the first LIDAR point, and a difference between a lateral position of the camera and a lateral position of the first LIDAR point; and
a second condition that a second value satisfies a second specified range different from the first specified range, the second value being identified based on a difference between a position of a center point of one of four line segments of a track box representing the target fusion track and a position of the first LIDAR point.

17. The method of claim 13, wherein the angle condition comprises a condition that, in a state in which the first LIDAR points are arranged in a decreasing order of angles between each of half lines from the point corresponding to the host vehicle to the first LIDAR points and the half line, a LIDAR point is included within a specified order, among the first LIDAR points.

18. The method of claim 13, wherein the distance condition comprises a condition that a LIDAR point is closest to the point corresponding to the host vehicle, among the second LIDAR points.

19. The method of claim 13, wherein the distance condition comprises a first condition that the at least one third LIDAR point corresponds to a smallest angle among angles between each of half lines from the point corresponding to the host vehicle to the second LIDAR points and the half line among the second LIDAR points, or a second condition that the at least one third LIDAR point is closest to the target fusion track among the second LIDAR points.

20. The method of claim 13, wherein:
the point corresponding to the host vehicle comprises a center point of a line segment representing a front bumper module of the host vehicle; and
the point corresponding to the target fusion track comprises a center point of a track box representing the camera track.
